(19) United States
(12) Patent Application Publication
(10) Pub. No.: US 2010/0318552 A1
(43) Pub. Date: Dec. 16, 2010

(54) SYSTEM AND A METHOD FOR PROVIDING INFORMATION TO A USER

(75) Inventor: Lyle Bruce Clarke, Lunderskov (DK)

Correspondence Address: HARNESS, DICKEY & PIERCE, P.L.C., P.O. BOX 8910, RESTON, VA, 20195, US

(73) Assignee: BANG & OLUFSEN A/S, STRUER (DK)

(21) Appl. No.: 12/449,691

(22) PCT Filed: Jan. 31, 2008
(86) PCT No.: PCT/EP2008/051179

§ 371 Date: Aug. 21, 2009

(51) Int. Cl. G06F 17/30

(52) U.S. Cl. 707/769; 707/E17.014

(57) ABSTRACT

A media presenter or e-book synchronizing with a server or central unit, where the server or central unit is adapted to perform multiple searches and provide the results in predetermined folders, and where, upon synchronization, the media presenter provides the received search results in corresponding folders therein.

The present invention relates to improvements in systems and methods for providing information to a user and in particular in relation to portable systems, such as electronic readers, for a user to download information onto in order to read this information while on the road or away from his/her computer/home/office.

Readers of this type has been investigated for some time, see e.g. U.S. Pat. No. 6,154,214 and EP1132829, but improvements have been found as to the operation and use thereof.

In a first aspect, the invention relates to a system for providing information to a user, the system comprising:
a portable unit comprising:
means for providing information to a user,
means for receiving and storing information to be provided to the user,
a second unit comprising:
means for performing one or more searches in information accessible thereby, each search being performed on the basis of a search strategy,
means for storing at least part of the results of the searches in a plurality of folders in the second unit,
means for transmitting, to the portable unit, the at least part of the results of the searches as well as an indication of in which folder the individual search result was stored,
   the portable unit being adapted to store the received search results in folders corresponding to the folders of the second unit.

In this context, a unit is portable if it may be carried and handled by a person. Portable units are units with the size and weight of e.g. lap top computers and PDA's.

Usually, the providing means are adapted to provide visual information to the user, such as a display based on LED's, a CRT, e-ink, plasma technology, or the like.

Naturally, the communication between the portable unit and the second unit may be performed using any desired standard and method, such as wireless technology (radio waves, IR, Bluetooth, WIFI, via the mobile telephone network, or the like) or based on wires, such as USB, FireWire, Ethernet or the like. This communication link may be up constantly or may be intermittent with suitable “synchronization”, when communication is desired/possible.

The information accessible may be information provided in a storage (optical or electrical) accessible by the second unit or may be accessible via a network, such as the WWW. This information may be the full information or a part thereof, such as appetizers of e.g. articles for which the user must pay in order to obtain the full article.

The storing means of any of the units may be any suitable storing means, such as RAM, ROM, PROM, EPROM, EEPROM, hard disc, floppy disc, DVD, CD-ROM, Flash, or the like.

According to the present aspect, the search results are provided in different folders in order to be able to e.g. separate the results of different searches. Naturally, the results of multiple searches may be provided in a single folder if desired.

This multiplicity of folders also exists on the portable unit, and the search results transmitted to the portable unit are stored in the correct folders on the basis of the indications received.

In this context, the indication may simply be data transmitted from the second unit to the portable unit describing the target folder(s) of the search results. Alternatively, the indication may be provided in the actual order in which the search results are forwarded. Also, search results from different folders may be transmitted in different manners, such as using different means, frequencies, wavelengths, timing, or the like, in order to provide the indication. In one embodiment, one folder is updated before another is, and the timing and order of this updating may indicate to the portable unit which folder is now to receive new search results.

Naturally, the searches and search strategies may be performed and prepared in any suitable manner. Searches and the search strategies used will depend heavily on the type of information and on how much information is available. A search on the WWW for articles relating to e.g. bees will result in a number of very different pieces of information, and these results may be filtered by adding to the search strategy further requirements, such as an author, a particular type of bee, a language, or a type of information (article, video, soundtrack, article, book, . . . ). This type of search will be quite different from a search in a video collection available in one's home after movies in which a particular actor stars.

An interesting type of search is a MOTS (More Of The Same) search which may be a more complex type of search in which e.g. words/terms, topic, genre, author, language, source, publisher, editor, contents, type (article, thesis, news, background, text book, or the like), or other bibliographic data, are used. of one or more pieces of information are analyzed and similar pieces of information sought for. This is explained in more detail further below.

Preferably, the search strategies are stored in the folders of the second unit in which the pertaining search results are stored. This makes the handling in the second unit easier.

Naturally, additional search strategies may be defined, and in this situation, the additional search strategy is either stored in an existing folder, or a new folder is provided for this search strategy.

In the preferred embodiment, the performing means of the second unit is adapted to perform the searches multiple sequential times, and wherein the transmitting means are adapted to transmit, for each time, only search results not present in the storing means of the portable unit.

Thus, the searches are performed multiple times, such as always or with predetermined intervals, and the results forwarded to the portable unit are only results not present therein. In this manner, the bandwidth required between the second unit and the portable unit is reduced. The second unit may have a log of search results previously forwarded to or presently stored in the portable unit. It may additionally be desired to ensure that a search result which at one point has been forwarded to the portable unit, but which has been deleted there from, is still not forwarded to the portable unit again. In this situation, it may be desired to ensure that at least search results which have been forwarded to the portable unit with a predetermine time interval, such as less than a predetermined time ago, are not retransmitted to the portable unit.

In one embodiment, the providing means is adapted to provide to the user a suggestion of one or more pieces of information which may be of interest. Thus, the user's habits and interests may be logged or monitored in order to identify that or those pieces of information which may be of the most interest for the user.

In this situation, it may be desired to identify one search result from each folder and present these alternatives to the user. In this manner, the search strategies may reflect different interests, and the pertaining results are stored in individual folders. Then, the user may be presented with an interesting search result of each of the identified interests, where after the user may select one and concentrate on that.

In one embodiment, the portable unit further comprises second means for performing a search in the information present in the storage means of the portable unit and on the basis of information provided on the providing means, the performing means being adapted to identify information in the storage means of the portable unit similar to the information provided on the providing means. This search may be a More Of The Same search for results of similar content/context/genre/topic/author/etc (see further above).

Thus, even though it is desired that the most complex, processor demanding searches are performed on the second unit, the portable unit may also be equipped with searching means. Naturally, a similar result may be one having the same or a related content/context/genre/topic/author/etc., but, in fact, results based on the same search strategy, such as results from the same folder, may be similar, whereby the search may be quite simple.

A reason for providing this type of search may be in order to be able to view all results of a given search strategy or folder, if the providing means of the portable unit is designed to only provide, e.g., a predetermined number of the search results of a given folder. Performing this “internal” search may then provide additional search results of that folder.

A second aspect of the invention relates to a method operating the system of the first aspect, the method comprising:
the portable unit receiving and storing information and providing the information to the user,
the second unit:
performing one or more searches in information accessible thereby, each search being performed on the basis of a search strategy,
storing at least part of the results of the searches in a plurality of folders in the second unit, and
transmitting, to the portable unit, the at least part of the results of the searches as well as an indication of in which folder the individual search result was stored,
   the portable unit storing the received search results in folders corresponding to the folders of the second unit.

Normally, the second and portable unit comprises a processor and storing means for holding the search results as well as instructions/software for controlling the processor. In addition, these two units normally also comprise a monitor/display and communication means for communicating there between and possibly also with other elements, such as the WWW, mobile telephones, or the like.

Preferably, the search strategies are stored in the folders of the second unit in which the pertaining search results are stored.

In a preferred embodiment, the performing step comprises performing the searches multiple sequential times, and wherein the transmitting step comprises only transmitting, for each time, search results not present in the storing means of the portable unit. Thus, the searches may be performed constantly, as may be the communication, or the searches and communication may be performed intermittently, such as when it is possible (such as when the two units are within reach for communication). Also, the searches may be performed with a predetermined interval, and the communication takes place, when there is data to communicate and/or when the units are able to communicate with each other.

In one embodiment, the providing step comprises providing to the user a suggestion of one or more pieces of information which may be of interest.

In one embodiment, the method further comprises the step of performing a search in the information present in the storage means of the portable unit and on the basis of information provided on the providing means, the performing step comprises identifying information in the storage means of the portable unit similar to the information provided on the providing means.

A third aspect of the invention relates to a system for providing information to a user, the system comprising:
a portable unit comprising:
means for providing information in the form of search results to a user,
means for receiving and storing search results to be provided to the user,
means allowing a user to select received search result(s),
means for logging which search result(s) is/are selected by the user and for deriving second information related to the logged information,
means for transmitting the second information,
a second unit comprising means for, a plurality of times:
performing one or more searches in information accessible thereby, each search being performed on the basis of a search strategy, the searches generating one or more search results,
transmitting at least part of the search results to the portable unit,
receiving the second information from the portable unit and adapting the search stratety/ies accordingly.

In this aspect, information is transmitted to the second unit as to which search results were selected by the user, such as which of the identified and transmitted search results were of interest to the user. Then, this information is used for adapting the search strategy/ies accordingly.

It should be noted that the second information may just as well be information as to which search results were of no interest to the user.

The actual adaptation of the search strategies on the basis of feedback of interesting/non-interesting search results is a known technique, which may be performed in numerous manners depending heavily on the search strategies and the type of material in which the searches is performed. Also, this depends on the second information. If the second information points to particular search terms/words or other parameters which are of particular interest or of no interest at all, these may be used in the search strategies. If the second information points to a more complex relationship between relevant and not relevant information, this may be used in the search strategies.

In one embodiment, the transmitting means is adapted to transmit, for each transmitted search result, an indication of the search strategy having identified it, and wherein the logging means are adapted to log at least the search strategy having identified the selected search result(s). In a simple manner, this may be used for deleting search strategies which result only or primarily in irrelevant search results.

In one embodiment, the portable unit further comprises means for identifying, upon an input from the user, information stored therein and which is similar to actual information selected by the user. This could be the “internal search” described further above. In one situation, the identifying means is adapted to identify search results stemming from the same search strategy as the actual information.

A fourth aspect relates to a method of operating the system according to the third aspect, the method comprising:
the portable unit:
receiving and storing information in the form of search results and providing the information to the user,
allowing the user to select received search result(s),
logging which search result(s) is/are selected by the user and deriving second information related to the logged information,
transmitting the second information,
the second unit performing, a plurality of times, the steps of:
performing one or more searches in information accessible thereby, each search being performed on the basis of a search strategy, the searches generating one or more search results,
transmitting at least part of the search results to the portable unit, and
receiving the second information from the first unit and adapting the search strategy/ies accordingly.

Thus, in one embodiment, the transmitting step comprises transmitting, for each transmitted search result, an indication of the search strategy having identified it, and wherein the logging step comprises logging at least the search strategy having identified the selected search result(s).

In another embodiment, the method further comprises the step of identifying, upon an input from the user, information stored therein and which is similar to actual information selected by the user. In one situation, the identifying step comprises identifying search results stemming from the same search strategy as the actual information.

A fifth aspect of the invention relates to a system for providing information to a user, the system comprising:
a portable unit comprising:
means for providing information in the form of search results to a user,
means for receiving and storing search results to be provided to the user,
means allowing a user to select received search result(s),
means for transmitting second information relating to selected search result(s),
a second unit comprising:
means for performing one or more searches in information accessible thereby, each search being performed on the basis of a search strategy, the searches generating one or more search results,
means for transmitting at least part of the search results to the portable unit,
means for receiving the second information from the portable unit and for performing a second search in the information accessible thereby after search results similar to the selected search result(s) relating to the second information, the second search identifying second search results,
means for transmitting at least part of the second search results to the portable unit,
   the receiving means being adapted to also receive the second search results and the providing means being adapted to provide at least part of the second search results to the user.

In this context, “similar” search results may be similar in any of a large number of ways. For written material, similarity may be in words/terms, topic, genre, author, language, source, publisher, editor, contents, type (article, thesis, news, background, text book, or the like), or other bibliographic data. All search results may be provided with one or more parameters describing the search result, these parameters may be the above-mentioned particulars. Then, the search for similar search results may be a search in these parameters. Alternatively, the search results may be analyzed in order to derive the relevant information from the search results proper.

In one situation, this search for similar search results may be performed a single time, as these results may only be relevant for a short while. Alternatively, this search is converted to a search strategy similar to the other search strategies, and the results may subsequently be provided to the portable unit in the same manner as the other search results.

In one embodiment, the system further comprises means for determining an actual point of the day/week/month wherein the providing means are adapted to provide information to the user depending on the actual point of the day/week/month. This may be relevant due to a person's interests may vary over the day/week/month but in a predictable manner. Thus, in order to adapt to the users interests, this variation may be taken into account.

In another embodiment, the portable unit further comprises means for identifying, in the storing means of the portable unit, search results similar to a selected search result, the providing means being adapted to provide at least of the identified search result(s). This may be the above-mentioned “internal search”.

As mentioned above, this search may be relevant in the situation where the providing means only is adapted to provide a predetermined number of search results, and where additional, similar search results are required/desired.

A sixth aspect of the invention relates to a method of operating the system according to the fifth aspect, the method comprising:
the portable unit:
receiving and storing information in the form of search results and providing the information to the user,
allowing the user to select received search result(s),
transmitting second information relating to selected search result(s),
the second unit:
performing one or more searches in information accessible thereby, each search being performed on the basis of a search strategy, the searches generating one or more search results,
transmitting at least part of the search results to the portable unit,
receiving the second information from the first unit and performing a second search in the information accessible thereby after search results similar to the selected search report relating to the second information, the second search identifying second search results,
transmitting at least part of the second search results to the portable unit,
   the receiving means further receiving the second search results and providing at least part of the second search results to the user.

This method may further comprise the step of determining an actual point of the day/week/month wherein the providing step comprises providing information to the user depending on the actual point of the day/week/month.

In addition, the method may further comprise the step of the portable unit identifying, in the storing means of the portable unit, search results similar to a selected search result, the providing comprising providing at least of the identified search result(s).

A seventh aspect of the invention relates to an apparatus for providing visual information to a user, the apparatus comprising:
a display,
means for controlling the display to provide the information to the user,
means for determining a rotation of the face of the user in relation to the display,
   the controlling means being adapted to rotate the information provided by the display in relation to a determined rotation of the face of the user.

It is noted that the present aspect primarily is suitable for use in portable apparatus in that the difference in the rotation of the face rarely changes, in relation to stationary apparatus, to a degree where rotation of the information is desired, as the user normally sits in a chair or stands in front of the monitor. Nevertheless, monitors etc. exist, which are rotatable and which may be interesting in the present context.

When a portable display is used for providing visible information, it has been found to be insufficient to have a gravity-determining sensor, in that when the user is lying on his/her side and thereby rotating the monitor in relation to gravity will confuse the display to rotate the text in a wrong direction. This will be corrected by the present aspect.

In general, the rotation of the face may be a dynamic rotation of the head or it may be the face's actual rotation in relation to e.g. a predetermined axis of the display or the information provided on the display. The actual rotation of the face may be determined in any desired manner, such as the position/extent of the nose, the relative positions of the ears, or, as is presently preferred, the positions of the eyes. A straight line through the positions of the eyes directly defines the rotation/direction of the face, and this rotation/direction may be compared to a rotation/direction of the display or the information provided thereon in order to determine whether these rotations/directions facilitate easy understanding or reading of the information provided. If the information is excessively rotated in relation to the rotation/direction of the face, the understanding of the information may be hard. Thus, the desire of rotating the information.

In one embodiment, the determining means comprise imaging means adapted to provide an image of at least a part of the face of the user, the image comprising positions of the eyes of the user. In this manner, the determination of the rotation/direction of the face is facilitated.

In one embodiment, the display has a displaying surface and a main displaying direction, the imaging means having a main imaging direction being at least substantially parallel to the main displaying direction. Normally, the main displaying direction of the display is perpendicular to a surface thereof (when plane). Thus, the imaging means may have a main imaging direction perpendicular to the plane or maybe rotated slightly in order to capture a face when positioned perfectly in a position/distance, where the full display may be viewed and the information provided thereon understood.

In another embodiment, the apparatus may further comprise means for providing the controlling means with information relating to a comparison between the determined rotation of the face and a predetermined direction of the provided information, the controlling means rotating the information on the basis of the comparison. This comparison may result in an angle or value describing a difference in the rotation/direction of the face and the information. The direction of the information may be determined by that of letters provided, or the horizontal/vertical axis of images or video provided on the display. The comparison may, e.g., be performed by the direction of lines of text and/or the horizontal axis of images/video and the direction between the eyes of the face.

Several actions may be taken on the basis of this angle/value. In one situation, the information may be rotated so as to adapt to the actual value/angle, or it may be rotated to that of a predetermined number of fixed (relative or absolute) rotations/angles of the information provided. An example of the latter situation being one in which the controlling means is adapted to rotate the information 90 degrees in any direction or 180 degrees. Thus, that rotation suiting the comparison best will be chosen.

Naturally, the determination of the rotation/direction of the face and the rotation of the information may be performed at fixed time intervals or constantly. Alternatively, the apparatus may comprise means for the user to activate in order to have the rotation determination performed. Such means may be a push button, a touch sensitive screen or area, or the apparatus may be activatable by voice, sound or movement (such as vibration).

One manner of quantifying an angle difference between the rotation of the face and the information provided is to quantify an angle difference between a direction of the information and a straight line between the eyes of the face when projected onto a plane defined by the display.

In addition, the apparatus may comprise means for analyzing image information from the imaging means and for determining whether the apparatus rests on a surface with the imaging means pointing toward the surface. This position may be used for e.g. communicating with other equipment, such as to receive information to be provided on the display, whereby the present apparatus may be used as the portable unit in any of the above aspects. However, it may be desirable to differ between the position where the display points downwards but is used for e.g. reading, and where the display points downward but is positioned on a surface (the imaging means sees nothing moving or nothing at all).

A final aspect of the invention relates to a method of operating the apparatus according to the seventh aspect, the method comprising:
providing information to the user on the display,
determining a position of the eyes of the user in relation to the display, and
rotating the information provided by the display in relation to a determined position/direction of the eyes of the user.

Then, the determining step could comprise imaging at least a part of the face of the user, the image comprising the positions of the eyes of the user.

Also, the display preferably has a displaying surface and a main displaying direction, the imaging step comprises providing imaging information related to a main imaging direction being at least substantially parallel to the main displaying direction.

In addition, the method may further comprise the step of providing the controlling means with information relating to a comparison between the determined rotation of the face and a predetermined direction of the provided information, the controlling means rotating the information on the basis of the comparison.

Also, the controlling step could comprise determining one of four rotations of the information provided, the four rotations being rotations of multiples of 90 degrees (0, 90, 180 or 270 degrees).

Finally, the method could comprise the step of analyzing image information from the imaging means and determining whether the apparatus rests on a surface with the imaging means pointing toward the surface.

Naturally, the individual aspects and the advantages thereof may be mixed in order to obtain even more interesting systems and apparatus/methods.

In the following, preferred embodiments of the invention will be described with reference to the drawing, wherein:

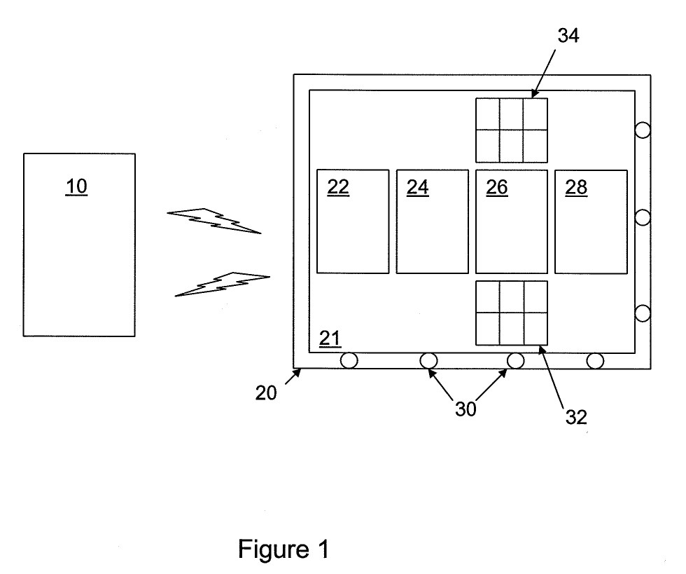

FIG. 1 illustrates an overall view of important components of a first preferred embodiment,

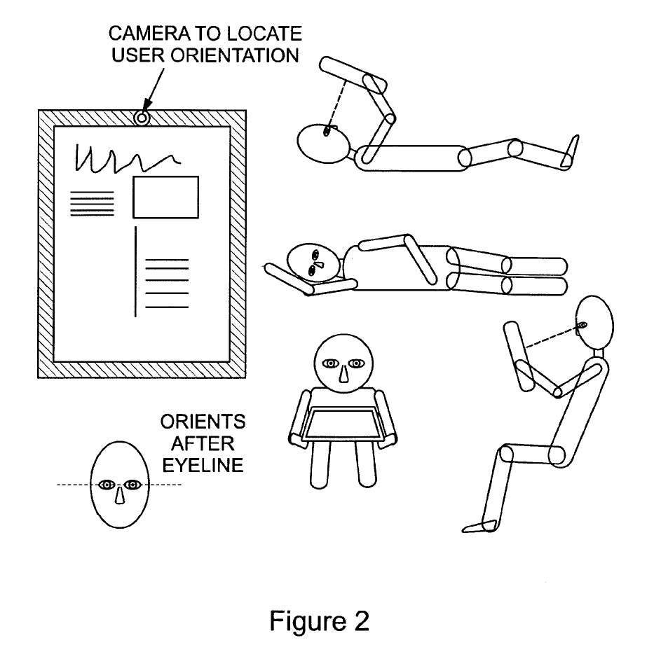

FIG. 2 illustrates a second preferred embodiment used by a user in different reading positions.

FIG. 1 illustrates the preferred embodiment in macroscopic terms in that it illustrates a stationary server-type system 10 which communicates with a portable unit 20 comprising a display 21 on which information may be provided.

The unit 20 comprises a number of buttons, 30, but may as well have a touch sensitive display covering all of or part of its surface, or any other manner may be used for entering selections etc. into the unit 20.

The server 10 comprises a storage holding a number of folders each having therein a search strategy. These searches are performed or updated at intervals or points in time defined by the user, and the search results relating to a search strategy are forwarded to the folder in which the search strategy is stored. Naturally, more than one search strategy may be stored in each folder.

The searches may be performed in any information available to the server, such as via the WWW or information stored on the server 10 or elements (such as disc storages) connected thereto. The searches may be for information of any type, such as articles, books, news, videos, music, or the like, and the search strategies may be defined in any manner and may be altered at any time (see below).

The server 10 also holds information relating to which search results are already present in the unit 20, so that these are not retransmitted thereto during synchronization.

Synchronization may be performed at regular intervals or points in time, or may take place, when the unit 20 and the server 10 are able to communicate. This communication may be via any of the known manners, such as via wires (Ethernet, FireWire, USB, or the like), or wireless (radio, radiation, Bluetooth, IR, GSM, mobile telephone network in general, or the like).

During synchronization, the unit 20 will receive new search results and store these in a folder structure similar to that of the server 10.

On the display 21, a number of areas 22, 24, 26, and 28 are provided for each illustrating a last read search result in each of four subjects. Each subject may be related to search strategies in one or more of the folders. Naturally, the user may define the subjects, and the search results suggested for each folder may be identified on the basis of a search performed on the search results stored in the unit 20 for search results relating to the subject.

The area 26, for example, illustrates the last read search result relating to the subject of area 26, for example news, sports, cats, or the like. In the area 22-26, only a thumbnail may be provided, depending on the extent of the search result and the size of the unit 20. Below the area 26, a number of smaller areas 32 are provided for illustrating to the user the 6 last read documents, the upper area to the left illustrating the document presently provided in the area 26. Alternatively, the areas 32 may illustrate the 6 most relevant, read search results.

Similarly, a number of smaller areas 34 are provided illustrating to the user the next documents within this subject. The prioritization of the documents as to their order of presentation may be made using any manner, such as a measure of relevance (see further below), or simply a date thereof.

From this view, naturally, and using the buttons 30 or other manipulation means, the user may select a search result and enlarge it in order to read/view it. The user may return to the present view and select or discard search results in any manner desired. In addition, the user may rate the search results in order to adapt the search strategy having identified non-relevant search results. Also, the user may instruct the unit 20 to generate new search strategies on the basis of a particular search result. This will be described further below.

A search result may be highlights of an article or the like, which is not freely available to the server 10. Thus, the pertaining search result may be an appetizer, such as an image and excerpts thereof (abstract, author, author credentials, publication date and publicist) and the price, and the user may be provided with this information together with a choice of whether to buy the full search result or not. If so, the server 10 will be instructed to purchase the search result and forward it to the unit 20 for future reading/viewing.

Naturally, the search strategies held on the server 10 may be adapted continuously to the interest of the user; which interest may very well change over time. This may be due to the user actually instructing the unit 20 or the server 10 to alter the search strategies, or it may be handled automatically by the unit 20 returning information to the server 10 as to which search results have been read/viewed by the user and which have been discarded or left out—or which rating the user may have given individual search results. On the basis of this information, the server 10 may put more or less emphasis on certain topics and thereby alter the search strategies.

In addition, the user may order the providing of new search strategies or new topics which are of interest. This may also be obtained by the user actually entering a search strategy or search terms of interest. Another manner, however, is the user instructing the unit 20 to provide more search results related to a presently viewed search result. This may then be a MOTS-search (More Of The Same), as is a known type of search in which interesting or characterizing phrases or terms are derived from the reference and used for searching for other references with the same phrases and terms. This would then constitute a new search strategy, which is either provided in its own folder on the server 10 and unit 20 (and may be provided as a new topic in a new area as the area 26 or may replace another topic), or may be provided in the folder and topic from which the original request stemmed. The first search performed by the server 10 with this search strategy is performed in the documents already present on the unit 20 but may also be extended to documents available outside the unit 20. In this manner, the search is performed on the server 10, which normally performs much faster searches than portable units.

In an alternative embodiment, the initial search on the basis of the documents already present on the unit 20 may be performed in the unit 20, in order to have instantaneous searching. This search may then be supplemented by a search performed by the server 10 on documents not present on the server 10.

On the unit 20, the number of available documents normally far exceeds that which is relevant to read. Thus, when reading through a suggested list of references will eventually, after a default number of references, revert the reader to the screen seen in the figure and thereby to other topics. If the user wishes to remain at the former topic, the user may perform a MOTS search on the unit in order to identify further references on the same topic. Naturally, the default number of references may be selected individually and may be a dynamic value changeable by the user.

In FIG. 2, a unit 20 is seen used by a user in different positions.

The unit of this embodiment has a camera 40 pointed in the general direction perpendicular to the plane of the display 21 in order to as often as possible image the face of the user.

From the image(s) of the user, the positions of the user's eyes may be determined as well as an angle between the upper edge of the display 21 and the user's eyes. Thus, it may be determined how the user's head is angled in relation to the display 21, and the text or images provided on the display 21 may be angled correspondingly in order for the text/images thereof to always be correctly angled in relation to the user's eyes.

In addition, the camera 40 may be used for determining whether the unit 20 is positioned face down on a surface (the camera 40 only sees darkness), whereby the unit 20 may turn itself of or to a power save mode.

1. A system for providing information to a user, the system comprising:
a portable unit comprising:
means for providing information to a user,
means for receiving and storing information to be provided to the user,
a second unit comprising:
means for performing one or more searches in information accessible thereby, each search being performed on the basis of a search strategy,
means for storing at least part of the results of the searches in a plurality of folders in the second unit,
means for transmitting, to the portable unit, the at least part of the results of the searches as well as an indication of in which folder the individual search result was stored,
the portable unit being adapted to store the received search results in folders corresponding to the folders of the second unit.

2. A system according to claim 1, wherein the search strategies are stored in the folders of the second unit in which the pertaining search results are stored.

3. A system according to claim 1, wherein the performing means of the second unit is adapted to perform the searches multiple sequential times, and wherein the transmitting means are adapted to transmit, for each time, only search results not present in the storing means of the portable unit.

4. A system according to claim 1, wherein the providing means is adapted to provide to the user a suggestion of one or more pieces of information which may be of interest.

5. A system according to claim 1, wherein the portable unit further comprises second means for performing a search in the information present in the storage means of the portable unit and on the basis of information provided on the providing means, the performing means being adapted to identify information in the storage means of the portable unit similar to the information provided on the providing means.

6. A method operating the system of claim 1, the method comprising:
the portable unit receiving and storing information and providing the information to the user,
the second unit:
performing one or more searches in information accessible thereby, each search being performed on the basis of a search strategy,
storing at least part of the results of the searches in a plurality of folders in the second unit,
and transmitting, to the portable unit, the at least part of the results of the searches as well as an indication of in which folder the individual search result was stored,
the portable unit storing the received search results in folders corresponding to the folders of the second unit.

7. A method according to claim 6, wherein the search strategies are stored in the folders of the second unit in which the pertaining search results are stored.

8. A method according to claim 6, wherein the performing step comprises performing the searches multiple sequential times, and wherein the transmitting step comprises only transmitting, for each time, search results not present in the storing means of the portable unit.

9. A method according to claim 6, wherein the providing step comprises providing to the user a suggestion of one or more pieces of information which may be of interest.

10. A method according to claim 6, further comprising the step of performing a search in the information present in the storage means of the portable unit and on the basis of information provided on the providing means, the performing step comprises identifying information in the storage means of the portable unit similar to the information provided on the providing means.

11. A system for providing information to a user, the system comprising:
a portable unit comprising:
means for providing information in the form of search results to a user,
means for receiving and storing search results to be provided to the user,
means allowing a user to select received search result(s),
means for logging which search result(s) is/are selected by the user and for deriving second information related to the logged information,
means for transmitting the second information,
a second unit comprising means for, a plurality of times:
performing one or more searches in information accessible thereby, each search being performed on the basis of a search strategy, the searches generating one or more search results,
transmitting at least part of the search results to the portable unit,
receiving the second information from the portable unit and adapting the search stratety/ies accordingly.

12. A system according to claim 11, wherein the transmitting means is adapted to transmit, for each transmitted search result, an indication of the search strategy having identified it, and wherein the logging means are adapted to log at least the search strategy having identified the selected search result(s).

13. A system according to claim 11, wherein the portable unit further comprises means for identifying, upon an input from the user, information stored therein and which is similar to actual information selected by the user.

14. A system according to claim 13, wherein the identifying means is adapted to identify search results stemming from the same search strategy as the actual information.

15. A method of operating the system according to claim 11, the method comprising:
the portable unit:
receiving and storing information in the form of search results and providing the information to the user,
allowing the user to select received search result(s),
logging which search result(s) is/are selected by the user and deriving second information related to the logged information,
transmitting the second information,
the second unit performing, a plurality of times, the steps of:
performing one or more searches in information accessible thereby, each search being performed on the basis of a search strategy, the searches generating one or more search results,
transmitting at least part of the search results to the portable unit, and
receiving the second information from the first unit and adapting the search strategies accordingly.

16. A method according to claim 15, wherein the transmitting step comprises transmitting, for each transmitted search result, an indication of the search strategy having identified it, and wherein the logging step comprises logging at least the search strategy having identified the selected search result(s).

17. A method according to claim 15, further comprising the step of identifying, upon an input from the user, information stored therein and which is similar to actual information selected by the user.

18. A method according to claim 17, wherein the identifying step comprises identifying search results stemming from the same search strategy as the actual information.

19. A system for providing information to a user, the system comprising:
a portable unit comprising:
means for providing information in the form of search results to a user,
means for receiving and storing search results to be provided to the user,
means allowing a user to select received search result(s),
means for transmitting second information relating to selected search result(s),
a second unit comprising:
means for performing one or more searches in information accessible thereby, each search being performed on the basis of a search strategy, the searches generating one or more search results,
means for transmitting at least part of the search results to the portable unit,
means for receiving the second information from the portable unit and for performing a second search in the information accessible thereby after search results similar to the selected search result(s) relating to the second information, the second search identifying second search results,
means for transmitting at least part of the second search results to the portable unit, the receiving means being adapted to also receive the second search results and the providing means being adapted to provide at least part of the second search results to the user.

20. A system according to claim 19, further comprising means for determining an actual point of the day/week/month wherein the providing means are adapted to provide information to the user depending on the actual point of the day/week/month.

21. A system according to claim 19, wherein the portable unit further comprises means for identifying, in the storing means of the portable unit, search results similar to a selected search result, the providing means being adapted to provide at least of the identified search result(s).

22. A method of operating the system according to claim 19, the method comprising:
the portable unit:
receiving and storing information in the form of search results and providing the information to the user,
allowing the user to select received search result(s),
transmitting second information relating to selected search result(s),
the second unit:
performing one or more searches in information accessible thereby, each search being performed on the basis of a search strategy, the searches generating one or more search results,
transmitting at least part of the search results to the portable unit,
receiving the second information from the first unit and performing a second search in the information accessible thereby after search results similar to the selected search report relating to the second information, the second search identifying second search results,
transmitting at least part of the second search results to the portable unit,
the receiving means further receiving the second search results and providing at least part of the second search results to the user.

23. A method according to claim 22, further comprising the step of determining an actual point of the day/week/month wherein the providing step comprises providing information to the user depending on the actual point of the day/week/month.

24. A system according to claim 22, further comprising the step of the portable unit identifying, in the storing means of the portable unit, search results similar to a selected search result, the providing comprising providing at least of the identified search result(s).

25. An apparatus for providing visual information to a user, the apparatus comprising:
a display,
means for controlling the display to provide the information to the user,
means for determining a rotation of the face of the user in relation to the display,
the controlling means being adapted to rotate the information provided by the display in relation to a determined rotation of the face of the user.

26. An apparatus according to claim 25, wherein the determining means comprise imaging means adapted to provide an image of at least a part of the face of the user, the image comprising positions of the eyes of the user.

27. An apparatus according to claim 26, wherein the display has a displaying surface and a main displaying direction, the imaging means having a main imaging direction being at least substantially parallel to the main displaying direction.

28. An apparatus according to claim 25, further comprising means for providing the controlling means with information relating to a comparison between the determined rotation of the face and a predetermined direction of the provided information, the controlling means rotating the information on the basis of the comparison.

29. An apparatus according to claim 25, wherein the controlling means is adapted to determine one of four rotations of the information provided, the four rotations being rotations of multiples of 90 degrees.

30. An apparatus according to claim 26, comprising means for analyzing image information from the imaging means and for determining whether the apparatus rests on a surface with the imaging means pointing toward the surface.

31. A method of operating the apparatus according to claim 25, the method comprising:
providing information to the user on the display,
determining a position of the eyes of the user in relation to the display, and
rotating the information provided by the display in relation to a determined position/direction of the eyes of the user.

32. A method according to claim 31, wherein the determining step comprises imaging at least a part of the face of the user, the image comprising the positions of the eyes of the user.

33. A method according to claim 31, wherein the display has a displaying surface and a main displaying direction, the imaging step comprises providing imaging information related to a main imaging direction being at least substantially parallel to the main displaying direction.

34. A method according to claim 31, further comprising the step of providing the controlling means with information relating to a comparison between the determined rotation of the face and a predetermined direction of the provided information, the controlling means rotating the information on the basis of the comparison.

35. A method according to claim 31, wherein the controlling step comprises determining one of four rotations of the information provided, the four rotations being rotations of multiples of 90 degrees.

36. A method according to claim 32, comprising the step of analyzing image information from the imaging means and determining whether the apparatus rests on a surface with the imaging means pointing toward the surface.
